(19) United States
(12) Patent Application Publication
(10) Pub. No.: US 2025/0214604 A1
(43) Pub. Date: Jul. 3, 2025

(54) Driving Policy Layer for High-Definition (HD) Mapping Platform

(71) Applicant: QUALCOMM Incorporated, San Diego, CA (US)

(72) Inventors: Nirnai ACH, Munich (DE); Kiran BANGALORE RAVI, Paris (FR); Hans Peter PESCHKE, Chengdu, Sichuan (CN); Senthil Kumar YOGAMANI, Headford, Galway (IE)

(21) Appl. No.: 18/397,971

(22) Filed: Dec. 27, 2023

(51) Int. Cl. B60W 60/00; G01C 21/00; G06N 3/08

(52) U.S. Cl. CPC B60W 60/001; G01C 21/3841; G06N 3/08; B60W 2556/40

(57) ABSTRACT

Trajectory planning techniques for high-definition (HD) mapping platforms are disclosed. The techniques can include obtaining multi-agent vehicle trajectory data associated with a map segment of an HD map, constructing, by a neural network, a trajectory value-based flow field for the map segment based on the multi-agent vehicle trajectory data, and configuring, for the map segment, trajectory planning parameters of a driving policy layer of the HD mapping platform based on the trajectory value-based flow field.

### BACKGROUND

### 1. Field of Disclosure

Aspects of the present disclosure generally relate to map generation and, more specifically to techniques for trajectory planning for high-definition (HD) mapping platforms.

### 2. Description of Related Art

A high-definition (HD) mapping platform can provide a robust framework for use by an autonomous vehicle to make driving control and navigation decisions. An overall coverage area of an HD map provided by an HD mapping platform can be logically divided into a plurality of map segments. With respect to each map segment, the HD mapping platform can describe the presence and characteristics of roadways, intersections, and other features, can indicate aspects of current or expected driving conditions along such roadways or in other regions within the map segment, and can specify rules for, or constraints upon, vehicle movement or navigation within the map segment. The HD mapping platform can use perception data (such as radar, lidar, or image data) and global navigation satellite system (GNSS) data (such as Global Positioning System (GPS) data) provided by a given autonomous vehicle to determine and provide driving control and navigation instructions for that autonomous vehicle.

### BRIEF SUMMARY

An example trajectory planning method for an HD mapping platform, according to this disclosure, may include obtaining multi-agent vehicle trajectory data associated with a map segment of an HD map, constructing, by a neural network, a trajectory value-based flow field for the map segment based on the multi-agent vehicle trajectory data, and configuring, for the map segment, trajectory planning parameters of a driving policy layer of the HD mapping platform based on the trajectory value-based flow field.

An example trajectory planning apparatus for an HD mapping platform, according to this disclosure, may include at least one memory and at least one processor communicatively coupled with the at least one memory, the at least one processor configured to obtain multi-agent vehicle trajectory data associated with a map segment of an HD map, construct, by a neural network, a trajectory value-based flow field for the map segment based on the multi-agent vehicle trajectory data, and configure, for the map segment, trajectory planning parameters of a driving policy layer of the HD mapping platform based on the trajectory value-based flow field.

An example non-transitory computer-readable medium, according to this disclosure, may store instructions for trajectory planning for an HD mapping platform the instructions including code to obtain multi-agent vehicle trajectory data associated with a map segment of an HD map, construct, by a neural network, a trajectory value-based flow field for the map segment based on the multi-agent vehicle trajectory data, and configure, for the map segment, trajectory planning parameters of a driving policy layer of the HD mapping platform based on the trajectory value-based flow field.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to aspects of the disclosure.

FIG. 2 is a block diagram illustrating an example layering scheme for an HD mapping platform.

FIG. 3 is a block diagram illustrating an example procedure for configuring a policy layer for an HD mapping platform.

FIG. 4 is a block diagram illustrating an example operating environment.

FIG. 5 is a block diagram illustrating an example method for trajectory planning for an HD mapping platform, according to aspects of the disclosure.

FIG. 6 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

Various aspects relate generally to map generation, and more particularly to techniques for trajectory planning for HD mapping platforms. According to aspects of the disclosure, to enable it to account for obstacles or regions to be avoided that may not be reflected in a current map version, an HD mapping platform can be configured with a driving policy layer. Functionality of the driving policy layer can use GPS data provided by vehicles traveling in a map segment to determine the trajectories traveled by those vehicles. Based on the traveled trajectories, characteristics of the travel environment in the map segment—characteristics that may not be reflected in a most recent map version—can be inferred, such as the presence of obstacles, construction zones, uneven road surfaces, and the like. For a given map segment, the driving policy layer can implement a value-based flow field that indicates values or costs of various possible trajectories in the map segment, based on the extent to which those trajectories do or do not avoid undesirable areas. A vehicle path planner at a vehicle can refer to the value-based flow field to identify desirable trajectories in conjunction with planning a travel path for the vehicle through the map segment, and by so doing, can achieve greater levels of safety and efficiency in conjunction with travel path planning. These benefits may be realized without imposing an added burden on the vehicle side, as flow field creation can be conducted centrally, based on GPS data that vehicles already provide to the cloud.

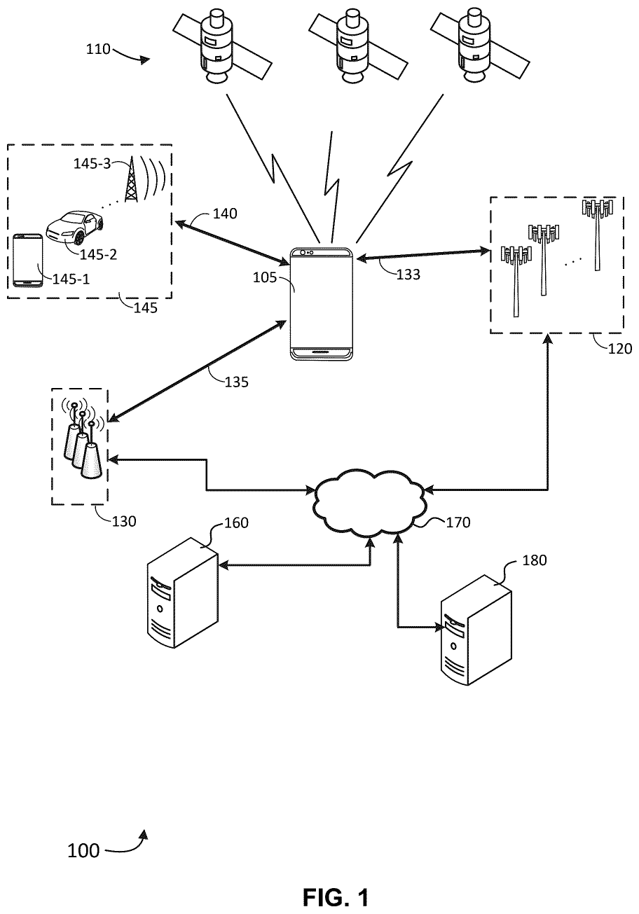

FIG. 1 is a simplified illustration of a positioning system 100 in which a UE 105, location server 160, and/or other components of the positioning system 100 can use the techniques provided herein for trajectory planning for an HD mapping platform, according to an embodiment. The techniques described herein may be implemented by one or more components of the positioning system 100. The positioning system 100 can include: a UE 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and/or Non-Terrestrial Network (NTN) satellites; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The UE 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the UE 105, according to some embodiments.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

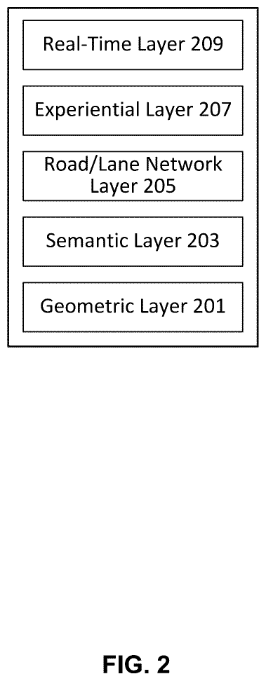

FIG. 2 is a block diagram illustrating an example layering scheme 200 for an HD mapping platform according to aspects of the disclosure. Layering scheme 200 includes a geometric layer 201, a semantic layer 203, a road/lane network layer 205, an experiential layer 207, and a real-time layer 209. Each layer of layering scheme 200 can generally represent a framework for conceptualizing, recognizing, and analyzing various characteristics of regions mapped using an HD mapping platform. Such characteristics can describe, for instance, attributes of roadways, obstacles, terrain, structures, and vehicles in the mapped regions.

Geometric layer 201 can describe physical dimensions and geometry of roadways and other traversable regions (or portions thereof) within HD map segments. For instance, geometric layer 201 can describe roadways in terms of geometric shapes, such as lines, strings, and polygons. Geometric layer 201 can specify point coordinates representing vertices of such shapes to define how they fit together to form a roadway or other traversable region (such as a driveway or parking lot, for instance) in a map segment.

Semantic layer 203 can designate, for various portions of (or locations in) roadways or other traversable regions in a map segment, various types of semantic classifications of significance in the context of vehicular navigation within the map segment. The significance of some such semantic classifications can take the form of rules or constraints upon driving behavior within or at the associated regions or locations. Semantic layer 203 can, for instance, classify particular portions of roadways as being subject to particular speed limits, indicate the directions of travel within various lanes of a roadway, and specify positions at which vehicles must stop (due to the presence of stop signs, for example).

Road/lane network layer 205 can generally define how roadways in an HD map fit together, and in that context, can describe characteristics of roadways (or portions thereof) based on their relationships with other roadways (or portions thereof). Some characteristics that road/lane network layer 205 describes can relate to roadway regions in the vicinity of intersections. For example, with respect to an intersection between multi-lane roads, road/lane network layer 205 can specify which lanes of the two roads merge into, mesh with, or conflict with each other (and how).

Experiential layer 207 can describe expectations regarding various portions of roadways or other traversable regions in a map segment based on previous observations of conditions therein. For example, experiential layer 207 can specify an expectation of reduced traffic flow along a particular portion of a roadway during a particular time period (during rush hour, for instance) based on prior observations of reduced traffic flow along that portion of the roadway during comparable time periods (during previous rush hours, for instance). In another example, experiential layer 207 can specify an expected likelihood of an accident occurring within a particular region based on a previously-observed accident rate within that region.

Real-time layer 209 can describe various aspects of current conditions within various portions of roadways or other traversable regions in a map segment. For example, real-time layer 209 can indicate a current rate of traffic flow along a particular portion of a roadway, the closure of a lane or other region of a roadway (such as for construction or due to an accident, for instance), or other relevant transient conditions within a map segment.

An HD mapping platform that implements layering scheme 200 may rely on perception data (such as radar, lidar, or image data) provided by vehicles in the field to determine the physical dimensions and geometry described by geometric layer 201 and the semantic classifications designated by semantic layer 203. However, in some scenarios, such perception data may not capture or reflect the existence of unusual driving conditions or road geometries (such as the presence of uneven roadway surfaces, roundabouts, multi-road intersections, or highway merges, poor visibility of traffic lights or signs, school zones, or market area boundaries) that influence driver behavior. The geometric layer 201 and semantic layer 203 may thus, under some circumstances, provide an incomplete basis for understanding driver behavior and vehicle interactions within some regions. This may result in increased risk of accidents, decreased efficiency, or both with respect to navigation using the HD mapping platform under such circumstances.

Disclosed herein are trajectory planning techniques for HD mapping platforms, which may be implemented to account for the aforementioned potential shortcomings associated with layering scheme 200. According to aspects of the disclosure, layering scheme 200 may be supplemented with a driving policy layer that accounts for effects on driver behavior caused by factors not captured by geometric layer 201 and semantic layer 203 (“implicit factors”). The driving policy layer can model the dynamics of vehicles in the driving environment, and can serve as a learned prior model for use in making vehicle navigation decisions. By using the driving policy layer to capture the effects of implicit factors, an HD mapping platform can provide enhanced levels of safety and efficiency.

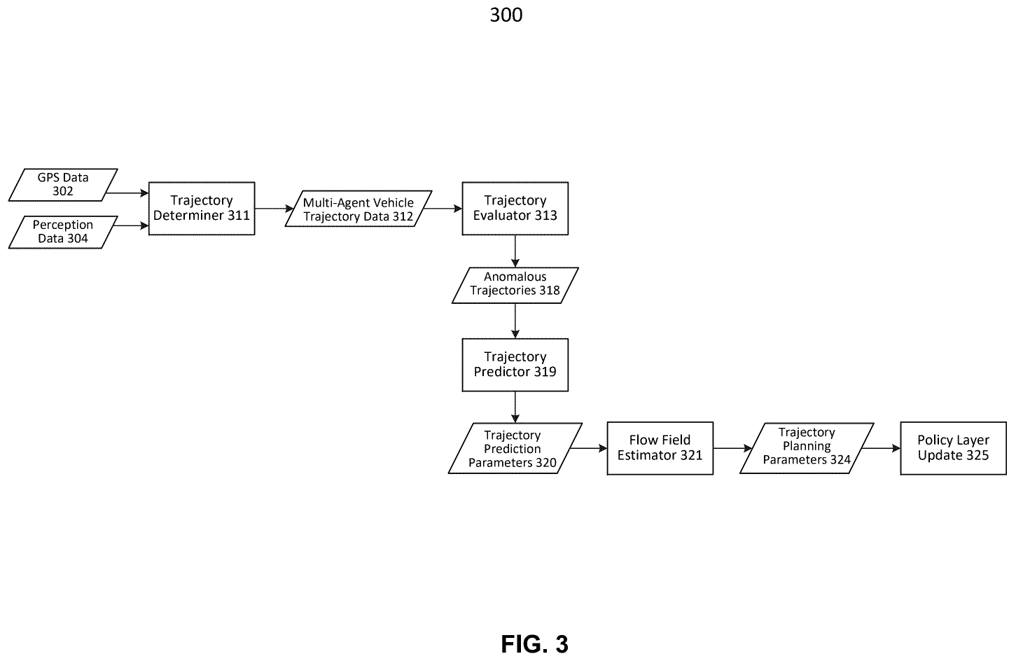

FIG. 3 is a block diagram illustrating an example procedure 300 for configuring such a driving policy layer for an HD mapping platform. According to procedure 300, based on GPS data 302 and perception data 304, a trajectory determiner 311 can generate multi-agent vehicle trajectory data 312. GPS data 302 can include GNSS navigation data, such as GPS data, consisting of coordinates traversed by driven trajectories in a map segment of an HD map. Perception data 304 can include sensor data, such as radar, lidar, or image data, captured by vehicles in conjunction with traversing driven trajectories in the map segment. Multi-agent vehicle trajectory data 312 can identify ego vehicle trajectories and associated neighboring agent trajectories. Ego vehicle trajectories can represent trajectories traversed by vehicles in the map segment, as defined by GNSS (such as GPS) coordinates provided by those vehicles. Neighboring agent trajectories can represent, with respect to a given ego vehicle trajectory, trajectories traversed by other vehicles in proximity to that vehicle. In some examples, vehicles in proximity to a given vehicle can be identified based on perception data 304, GPS data 302, or both that indicates their proximity.

Based on multi-agent vehicle trajectory data 312, a trajectory evaluator 313 can identify anomalous trajectories 318. According to aspects of the disclosure, ego vehicle trajectories (among those described by multi-agent vehicle trajectory data 312) that differ significantly—such as may be quantified by one or more rules or criteria—from their associated neighboring agent trajectories may be classified as anomalous trajectories 318. Based on anomalous trajectories 318, a trajectory predictor 319 may determine trajectory prediction parameters 320. Trajectory prediction parameters 320 may represent parameters according to which the HD mapping platform can predict future driven trajectories in the map segment.

Based on trajectory prediction parameters 320, a flow field estimator 321 can determine trajectory planning parameters 324 for use by motion planners at vehicles controlled or served by the HD mapping platform to make decisions regarding paths to be traveled in or through the map segment. According to aspects of the disclosure, flow field estimator 321 can be implemented using a neural network, such as a deep neural network (DNN). According to aspects of the disclosure, flow field estimator 321 can create a dense trajectory flow field with a corresponding cost or value function. According to aspects of the disclosure, the cost or value function can specify costs or values associated with the various possible trajectories in the trajectory space, and may be usable to identify an optimal or desirable trajectory. According to aspects of the disclosure, via a policy layer update 325, a driving policy layer of the HD mapping platform can be configured to apply the trajectory planning parameters 324.

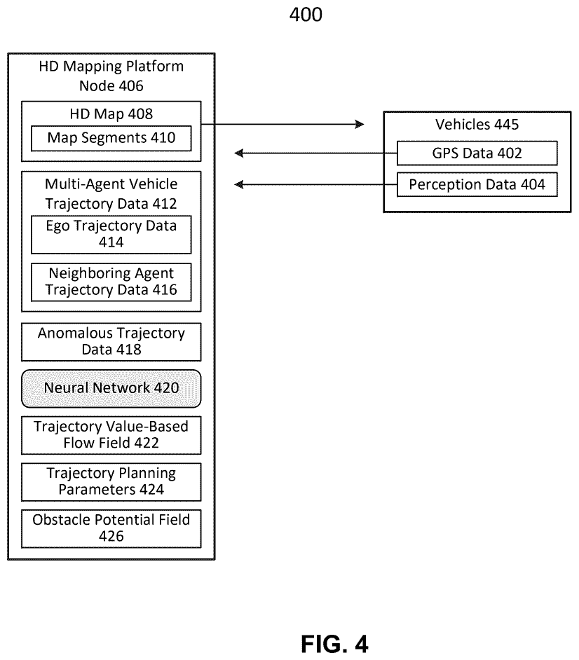

FIG. 4 is a block diagram illustrating an example operating environment 400 in which techniques for trajectory planning for an HD mapping platform may be applied according to aspects of the disclosure. In operating environment 400, an HD mapping platform node 406 implements a driving policy layer, such as may be configured according to procedure 300 of FIG. 3, for an HD map 408 that it makes available to a plurality of vehicles 445. The HD map 408 includes a plurality of map segments 410. As some of vehicles 445 move within or through a given map segment 410 they can provide GPS data 402 and perception data 404 to the HD mapping platform node 406. GPS data 402 can include GNSS navigation data, such as GPS data, consisting of coordinates traversed by trajectories driven in the map segment 410 by the vehicles 445. GPS data 402 can also include timestamps indicating when such coordinates were traversed. Perception data 304 can include sensor data, such as radar, lidar, or image data, captured by the vehicles 445 in conjunction with traversing those driven trajectories in the map segment. Perception data 304 can also include timestamps indicating when such sensor data was captured.

According to aspects of the disclosure, the HD mapping platform node 406 can obtain multi-agent vehicle trajectory data 412 by analyzing GPS data 402 and perception data 404 provided by vehicles 445. The multi-agent vehicle trajectory data 412 can include ego trajectory data 414 and neighboring agent trajectory data 416. The ego trajectory data 414 can describe trajectories traversed by vehicles 445 in the map segment 410 as defined by GNSS (such as GPS) coordinates provided by those vehicles. In some examples, ego trajectory data 414 can include sequences of time-stamped GNSS coordinates. The neighboring agent trajectory data 416 can describe neighboring agent trajectories associated with various ego vehicle trajectories described by ego trajectory data 414. Such neighboring agent trajectories can represent, with respect to their associated ego vehicle trajectories, trajectories traversed by other vehicles in proximity to the ego vehicles.

According to aspects of the disclosure, the HD mapping platform node 406 can construct a trajectory flow field using a neural network 420. In some examples, the neural network 420 may be a deep neural network (DNN). In some examples, HD mapping platform node 406 can train the neural network 420 to predict future driven trajectories based on past future trajectories. In some examples, the HD mapping platform node 406 can train the neural network 420 based on driven trajectories associated with the map segment 410, as described by ego trajectory data 414. In some such examples, HD mapping platform node 406 can generate anomalous trajectory data 418 describing trajectories that are identified, from among those described by ego trajectory data 414, as being anomalous, and can train the neural network 420 based on the anomalous trajectory data 418. In some examples, HD mapping platform node 406 can identify such anomalous trajectories based on based on ego trajectory data 414 and neighboring agent trajectory data 416. In some examples, HD mapping platform node 406 can identify ego vehicles trajectories described by ego trajectory data 414 as being anomalous when they differ significantly—such as may be quantified by one or more rules or criteria—from their associated neighboring agent trajectories described by neighboring agent trajectory data 416.

According to aspects of the disclosure, the HD mapping platform node 406 can use the neural network 420 to create a trajectory value-based flow field 422 with a corresponding cost or value function. According to aspects of the disclosure, the cost or value function can specify an associated cost or value for each possible trajectory in the trajectory space for the map segment 410. According to aspects of the disclosure, the HD mapping platform node 406 can configure, for the map segment 410, trajectory planning parameters 424 of a driving policy layer of the HD mapping platform. According to aspects of the disclosure, the trajectory planning parameters 424 can be parameters for use by motion planners at vehicles 445 controlled or served by the HD mapping platform to make decisions regarding paths to be traveled in or through the map segment, in view of costs or values defined by the cost or value function.

In some examples, the HD mapping platform node 406 can implement an implicit obstacle layer for the HD mapping platform. According to aspects of the disclosure, the implicit obstacle layer can be implemented to account for the implied presence, in some regions within the map segment 410, of obstacles or other obstructions that are not known to other layers of the HD mapping platform. According to aspects of the disclosure, the HD mapping platform node 406 can generate an obstacle potential field 426 for the map segment 410 based on the trajectory value-based flow field 422, and can update the implicit obstacle layer for the HD mapping platform based on the obstacle potential field 426. In some examples, the HD mapping platform node 406 can generate the obstacle potential field 426 for the map segment 410 based on analysis of flow field divergence in the trajectory value-based flow field 422.

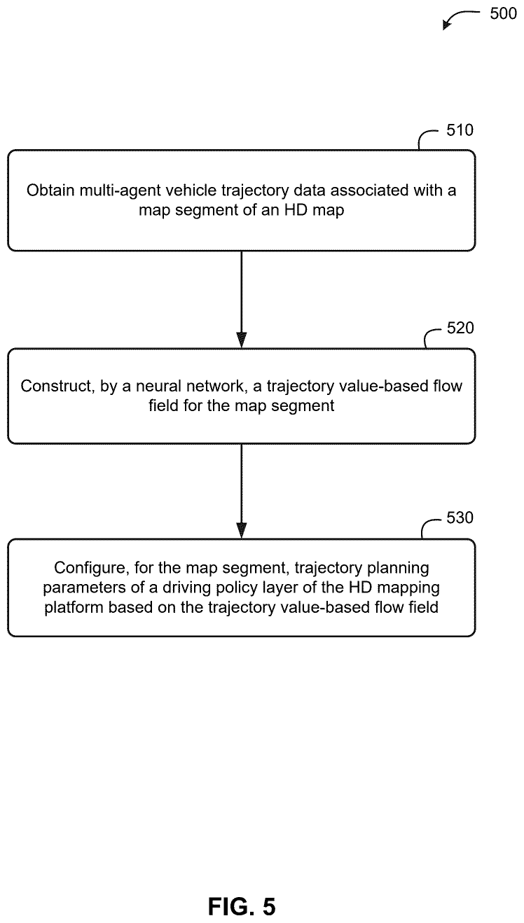

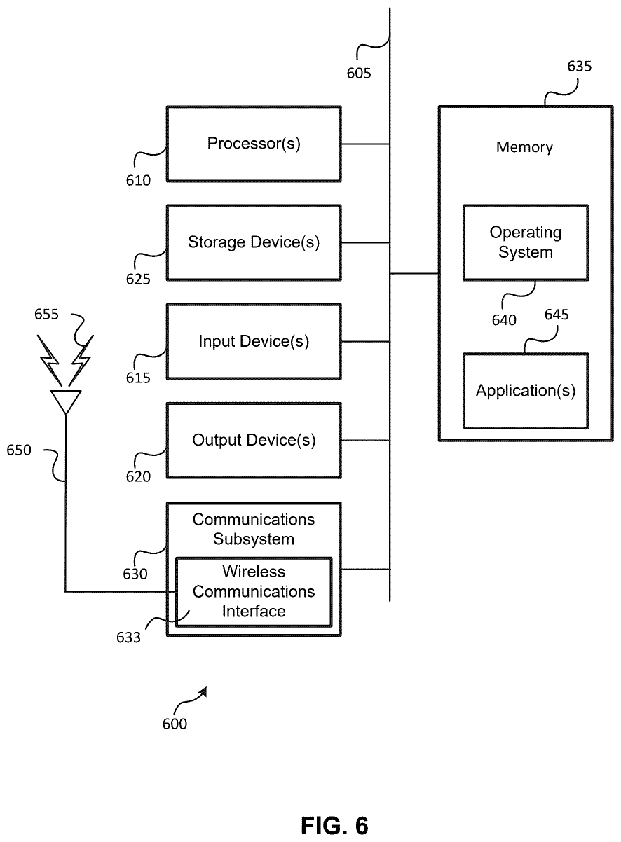

FIG. 5 is a block diagram illustrating an example method 500 for trajectory planning for an HD mapping platform, according to aspects of the disclosure. According to aspects of the disclosure, means for performing the functionality illustrated in one or more of the blocks shown in FIG. 5 may be performed by hardware and/or software components of a computer system. Example components of a computer system are illustrated in FIG. 6, which is described in more detail below. In some examples, HD mapping platform node 406 may perform the functionality illustrated in one or more of the blocks shown in FIG. 5 in operating environment 400 of FIG. 4.

At block 510, the functionality comprises obtaining multi-agent vehicle trajectory data associated with a map segment of an HD map. For example, in operating environment 400 of FIG. 4, HD mapping platform node 406 may obtain multi-agent vehicle trajectory data 412 associated with a map segment 410 of HD map 408. Means for performing functionality at block 510 may comprise a bus 605, processor(s) 610, storage device(s) 625, communications subsystem 630, memory 635, and/or other components of a computer system, as illustrated in FIG. 6.

In some examples, the multi-agent vehicle trajectory data may be obtained by analyzing GPS data and perception data received from vehicles traveling in or through the map segment. For example, in operating environment 400 of FIG. 4, HD mapping platform node 406 may obtain multi-agent vehicle trajectory data 412 associated with a map segment 410 of HD map 408 by analyzing GPS data 402 and perception data 404 received from vehicles 445 traveling in or through that map segment 410. In some examples, the multi-agent vehicle trajectory data can include, for each of one or more vehicles, ego trajectory data associated with that vehicle and neighboring agent trajectory data associated with one or more neighboring vehicles. For example, in operating environment 400 of FIG. 4, the multi-agent vehicle trajectory data 412 can include, for each of one or more vehicles 445, ego trajectory data 414 associated with that vehicle 445 and neighboring agent trajectory data 416 associated with one or more neighboring vehicles 445. In some examples, the multi-agent vehicle trajectory data can include global navigation satellite system (GNSS) navigation data associated with a plurality of driven trajectories in the map segment. In some such examples, the GNSS navigation data can include Global Positioning System (GPS) navigation data.

At block 520, the functionality comprises constructing, by a neural network, a trajectory value-based flow field for the map segment based on the multi-agent vehicle trajectory data. For example, in operating environment 400 of FIG. 4, HD mapping platform node 406 may construct, by neural network 420, a trajectory value-based flow field 422 for a map segment 410 based on multi-agent vehicle trajectory data 412 associated with the map segment 410. Means for performing functionality at block 520 may comprise a bus 605, processor(s) 610, storage device(s) 625, communications subsystem 630, memory 635, and/or other components of a computer system, as illustrated in FIG. 6. In some examples, the neural network can be a deep neural network (DNN).

In some examples, constructing the trajectory value-based flow field for the map segment based on the multi-agent vehicle trajectory data can include assessing values of potential trajectories associated with positions within the map segment according to a trajectory value function. For example, in operating environment 400 of FIG. 4, the HD mapping platform node 406 can use the neural network 420 to create, for a map segment 410, a trajectory value-based flow field 422 with a corresponding trajectory value function, and in conjunction with constructing the trajectory value-based flow field 422 for the map segment 410, can assess values of potential trajectories associated with positions within the map segment 410 according to the trajectory value function. In some examples, the neural network can be trained based on driven trajectories associated with the map segment. In some such examples, training the neural network based on the driven trajectories associated with the map segment can include identifying anomalous trajectories among the driven trajectories and training the neural network based on the anomalous trajectories. For example, in operating environment 400 of FIG. 4, the HD mapping platform node 406 can generate anomalous trajectory data 418 describing anomalous trajectories among the driven trajectories described by ego trajectory data 414, and can train the neural network 420 based on the anomalous trajectory data 418.

At block 530, the functionality comprises configuring, for the map segment, trajectory planning parameters of a driving policy layer of the HD mapping platform based on the trajectory value-based flow field. For example, in operating environment 400 of FIG. 4, HD mapping platform node 406 may configure, for a map segment 410, trajectory planning parameters 424 of a driving policy layer of the HD mapping platform based on the trajectory value-based flow field 422. Means for performing functionality at block 530 may comprise a bus 605, processor(s) 610, storage device(s) 625, communications subsystem 630, memory 635, and/or other components of a computer system, as illustrated in FIG. 6.

In some examples, an obstacle potential field can be generated for the map segment based on the trajectory value-based flow field, and an implicit obstacle layer of the HD mapping platform can be updated based on the obstacle potential field. For example, in operating environment 400 of FIG. 4, the HD mapping platform node 406 can generate an obstacle potential field 426 for a map segment 410 based on a trajectory value-based flow field 422 for the map segment 410, and can update an implicit obstacle layer of the HD mapping platform based on the obstacle potential field 426. In some examples, the obstacle potential field can be generated based on analysis of flow field divergence in the trajectory value-based flow field. For example, in operating environment 400 of FIG. 4, the HD mapping platform node 406 can generate an obstacle potential field 426 for a map segment 410 based on an analysis of flow field divergence in a trajectory value-based flow field 422 for the map segment 410.

FIG. 6 is a block diagram of an embodiment of a computer system 600, which may be used, in whole or in part, to provide the functions of one or more components as described in the embodiments herein. According to aspects of the disclosure, computer system 600 can be used in some examples to implement HD mapping platform node 406 of FIG. 4, method 500 of FIG. 5, or both. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. In addition, it can be noted that components illustrated by FIG. 6 can be localized to a single device and/or distributed among various networked devices, which may be disposed at different geographical locations.

The computer system 600 is shown comprising hardware elements that can be electrically coupled via a bus 605 (or may otherwise be in communication, as appropriate). The hardware elements may include processor(s) 610, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 600 also may comprise one or more input devices 615, which may comprise without limitation a mouse, a keyboard, a camera, a microphone, and/or the like; and one or more output devices 620, which may comprise without limitation a display device, a printer, and/or the like.

The computer system 600 may further include (and/or be in communication with) one or more non-transitory storage devices 625, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 600 may also include a communications subsystem 630, which may comprise wireless communication technologies managed and controlled by a wireless communication interface 633, as well as wired communication technologies (such as Ethernet, coaxial communications, universal serial bus (USB), and the like). The wired communication technologies can be managed and controlled by a wired communication interface (not shown in FIG. 6). The wireless communication interface 633 may comprise one or more wireless transceivers that may send and receive wireless signals 655 (e.g., signals according to 5G NR or LTE) via wireless antenna(s) 650. Thus the communications subsystem 630 may comprise a modem, a network card (wireless or wired), an infrared communication device, a wireless communication device, and/or a chipset, and/or the like, which may enable the computer system 600 to communicate on any or all of the communication networks described herein to any device on the respective network, including a User Equipment (UE), base stations and/or other TRPs, and/or any other electronic devices described herein. Hence, the communications subsystem 630 may be used to receive and send data as described in the embodiments herein.

In many embodiments, the computer system 600 will further comprise a working memory 635, which may comprise a RAM or ROM device, as described above. Software elements, shown as being located within the working memory 635, may comprise an operating system 640, device drivers, executable libraries, and/or other code, such as one or more applications 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 625 described above. In some cases, the storage medium might be incorporated within a computer system, such as computer system 600. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. An example trajectory planning method for a high-definition (HD) mapping platform, comprising: obtaining multi-agent vehicle trajectory data associated with a map segment of an HD map; constructing, by a neural network, a trajectory value-based flow field for the map segment based on the multi-agent vehicle trajectory data; and configuring, for the map segment, trajectory planning parameters of a driving policy layer of the HD mapping platform based on the trajectory value-based flow field.
Clause 2. The method of clause 1, wherein constructing the trajectory value-based flow field for the map segment based on the multi-agent vehicle trajectory data includes assessing values of potential trajectories associated with positions within the map segment according to a trajectory value function.
Clause 3. The method of clause 1 or 2, further comprising: generating an obstacle potential field for the map segment based on the trajectory value-based flow field; and updating an implicit obstacle layer of the HD mapping platform based on the obstacle potential field.
Clause 4. The method of any of clauses 1-3, comprising generating the obstacle potential field for the map segment based on analysis of flow field divergence in the trajectory value-based flow field.
Clause 5. The method of any of clauses 1-4, wherein the multi-agent vehicle trajectory data includes, for each of one or more vehicles: ego trajectory data associated with that vehicle; and neighboring agent trajectory data associated with one or more neighboring vehicles.
Clause 6. The method of any of clauses 1-5, further comprising training the neural network based on driven trajectories associated with the map segment.
Clause 7. The method of any clauses 1-6, wherein training the neural network based on the driven trajectories associated with the map segment includes identifying anomalous trajectories among the driven trajectories and training the neural network based on the anomalous trajectories.
Clause 8. The method of any of clauses 1-7, wherein the multi-agent vehicle trajectory data includes global navigation satellite system (GNSS) navigation data associated with a plurality of driven trajectories in the map segment.
Clause 9. The method of any of clauses 1-8, wherein the GNSS navigation data includes global positioning system (GPS) navigation data.
Clause 10. An trajectory planning apparatus for a high-definition (HD) mapping platform, comprising: at least one memory; and at least one processor communicatively coupled with the at least one memory, the at least one processor configured to: obtain multi-agent vehicle trajectory data associated with a map segment of an HD map; construct, by a neural network, a trajectory value-based flow field for the map segment based on the multi-agent vehicle trajectory data; and configure, for the map segment, trajectory planning parameters of a driving policy layer of the HD mapping platform based on the trajectory value-based flow field.
Clause 11. The coordinating device of clauses 10, wherein to construct the trajectory value-based flow field for the map segment based on the multi-agent vehicle trajectory data, the at least one processor is configured to assess values of potential trajectories associated with positions within the map segment according to a trajectory value function.
Clause 12. The coordinating device of any of clauses 10 or 11, wherein the at least one processor is further configured to: generate an obstacle potential field for the map segment based on the trajectory value-based flow field; and update an implicit obstacle layer of the HD mapping platform based on the obstacle potential field.
Clause 13. The coordinating device of any of clauses 10-12, wherein the at least one processor is configured to generate the obstacle potential field for the map segment based on analysis of flow field divergence in the trajectory value-based flow field.
Clause 14. The coordinating device of any of clauses 10-13, wherein the multi-agent vehicle trajectory data includes, for each of one or more vehicles: ego trajectory data associated with that vehicle; and neighboring agent trajectory data associated with one or more neighboring vehicles.
Clause 15. The coordinating device of any of clauses 10-14, wherein the at least one processor is further configured to train the neural network based on driven trajectories associated with the map segment.
Clause 16. The coordinating device of any of clauses 10-15, wherein to train the neural network based on the driven trajectories associated with the map segment, the at least one processor is configured to identify anomalous trajectories among the driven trajectories and train the neural network based on the anomalous trajectories.
Clause 17. The coordinating device of any of clauses 10-16, wherein the multi-agent vehicle trajectory data includes global navigation satellite system (GNSS) navigation data associated with a plurality of driven trajectories in the map segment.
Clause 18. The coordinating device of any of clauses 10-17, wherein the GNSS navigation data includes global positioning system (GPS) navigation data.
Clause 19. An example non-transitory computer-readable medium storing instructions for trajectory planning for a high-definition (HD) mapping platform, the instructions including code to: obtain multi-agent vehicle trajectory data associated with a map segment of an HD map; construct, by a neural network, a trajectory value-based flow field for the map segment based on the multi-agent vehicle trajectory data; and configure, for the map segment, trajectory planning parameters of a driving policy layer of the HD mapping platform based on the trajectory value-based flow field.
Clause 20. The non-transitory computer-readable medium of clause 19, wherein to construct the trajectory value-based flow field for the map segment based on the multi-agent vehicle trajectory data, the instructions include code to assess values of potential trajectories associated with positions within the map segment according to a trajectory value function.

What is claimed is:

1. A trajectory planning method for a high-definition (HD) mapping platform, comprising:
obtaining multi-agent vehicle trajectory data associated with a map segment of an HD map;
constructing, by a neural network, a trajectory value-based flow field for the map segment based on the multi-agent vehicle trajectory data; and
configuring, for the map segment, trajectory planning parameters of a driving policy layer of the HD mapping platform based on the trajectory value-based flow field.

2. The trajectory planning method of claim 1, wherein constructing the trajectory value-based flow field for the map segment based on the multi-agent vehicle trajectory data includes assessing values of potential trajectories associated with positions within the map segment according to a trajectory value function.

3. The trajectory planning method of claim 1, further comprising:
generating an obstacle potential field for the map segment based on the trajectory value-based flow field; and
updating an implicit obstacle layer of the HD mapping platform based on the obstacle potential field.

4. The trajectory planning method of claim 3, comprising generating the obstacle potential field for the map segment based on analysis of flow field divergence in the trajectory value-based flow field.

5. The trajectory planning method of claim 1, wherein the multi-agent vehicle trajectory data includes, for each of one or more vehicles:
ego trajectory data associated with that vehicle; and
neighboring agent trajectory data associated with one or more neighboring vehicles.

6. The trajectory planning method of claim 1, further comprising training the neural network based on driven trajectories associated with the map segment.

7. The trajectory planning method of claim 6, wherein training the neural network based on the driven trajectories associated with the map segment includes identifying anomalous trajectories among the driven trajectories and training the neural network based on the anomalous trajectories.

8. The trajectory planning method of claim 1, wherein the multi-agent vehicle trajectory data includes global navigation satellite system (GNSS) navigation data associated with a plurality of driven trajectories in the map segment.

9. The trajectory planning method of claim 8, wherein the GNSS navigation data includes global positioning system (GPS) navigation data.

10. A trajectory planning apparatus for a high-definition (HD) mapping platform, comprising:
at least one memory; and
at least one processor communicatively coupled with the at least one memory, the at least one processor configured to:
obtain multi-agent vehicle trajectory data associated with a map segment of an HD map;
construct, by a neural network, a trajectory value-based flow field for the map segment based on the multi-agent vehicle trajectory data; and
configure, for the map segment, trajectory planning parameters of a driving policy layer of the HD mapping platform based on the trajectory value-based flow field.

11. The trajectory planning apparatus of claim 10, wherein to construct the trajectory value-based flow field for the map segment based on the multi-agent vehicle trajectory data, the at least one processor is configured to assess values of potential trajectories associated with positions within the map segment according to a trajectory value function.

12. The trajectory planning apparatus of claim 10, wherein the at least one processor is further configured to:
generate an obstacle potential field for the map segment based on the trajectory value-based flow field; and
update an implicit obstacle layer of the HD mapping platform based on the obstacle potential field.

13. The trajectory planning apparatus of claim 12, wherein the at least one processor is configured to generate the obstacle potential field for the map segment based on analysis of flow field divergence in the trajectory value-based flow field.

14. The trajectory planning apparatus of claim 10, wherein the multi-agent vehicle trajectory data includes, for each of one or more vehicles:
ego trajectory data associated with that vehicle; and
neighboring agent trajectory data associated with one or more neighboring vehicles.

15. The trajectory planning apparatus of claim 10, wherein the at least one processor is further configured to train the neural network based on driven trajectories associated with the map segment.

16. The trajectory planning apparatus of claim 15, wherein to train the neural network based on the driven trajectories associated with the map segment, the at least one processor is configured to identify anomalous trajectories among the driven trajectories and train the neural network based on the anomalous trajectories.

17. The trajectory planning apparatus of claim 10, wherein the multi-agent vehicle trajectory data includes global navigation satellite system (GNSS) navigation data associated with a plurality of driven trajectories in the map segment.

18. The trajectory planning apparatus of claim 17, wherein the GNSS navigation data includes global positioning system (GPS) navigation data.

19. A non-transitory computer-readable medium storing instructions for trajectory planning for a high-definition (HD) mapping platform, the instructions including code to:
obtain multi-agent vehicle trajectory data associated with a map segment of an HD map;
construct, by a neural network, a trajectory value-based flow field for the map segment based on the multi-agent vehicle trajectory data; and
configure, for the map segment, trajectory planning parameters of a driving policy layer of the HD mapping platform based on the trajectory value-based flow field.

20. The non-transitory computer-readable medium of claim 19, wherein to construct the trajectory value-based flow field for the map segment based on the multi-agent vehicle trajectory data, the instructions include code to assess values of potential trajectories associated with positions within the map segment according to a trajectory value function.
